(19) United States
(12) Patent Application Publication
(10) Pub. No.: US 2026/0163127 A1
(43) Pub. Date: Jun. 11, 2026

(54) Battery Cell

(71) Applicant: SK On Co., Ltd., Seoul (KR)

(72) Inventors: Ho Jin HWANG, Daejeon (KR); Young Ha KIM, Daejeon (KR); Sung Hee MIN, Daejeon (KR); Ha Neul SONG, Daejeon (KR); Ga Yeong YOO, Daejeon (KR); Min Jae LEE, Daejeon (KR); Min Ji LEE, Daejeon (KR); Sang Pyo LEE, Daejeon (KR)

(21) Appl. No.: 19/415,974

(22) Filed: Dec. 11, 2025

(30) Foreign Application Priority Data
Dec. 11, 2024 (KR) 10-2024-0183546

(51) Int. Cl. H01M 50/105; H01M 50/178

(52) U.S. Cl. CPC H01M 50/105; H01M 50/178

(57) ABSTRACT

The present disclosure relates to a battery cell, the battery cell according to an embodiment may comprise a case outer member having a receiving space therein, and an electrode assembly received in the receiving space, wherein the case outer member includes a sealing portion formed by bending a plurality of sealing segments.

### CROSS-REFERENCE TO RELATED PATENT APPLICATION

The present application claims priority under 35 U.S.C. § 119a to Korean patent application number 10-2024-0183546 filed on Dec. 11, 2024, in the Korean Intellectual Property Office, the entire disclosure of which is incorporated by reference herein.

### BACKGROUND OF THE DISCLOSURE

### 1. Field

The present disclosure relates to a battery cell, and more particularly to a battery cell with excellent stability.

### 2. Description of the Related Art

A secondary battery is a battery that converts electrical energy into chemical energy and stores it so that it can be reused multiple times by charging and discharging. Secondary batteries are widely used in various industries due to their economical and eco-friendly characteristics. In particular, lithium secondary batteries are widely utilized across industries, including mobile devices that require high-density energy.

The working principle of lithium secondary batteries is an electrochemical oxidation-reduction reaction, which means that electricity is generated by the movement of lithium ions and charged in the opposite process. In the case of a lithium secondary battery, the phenomenon of lithium ions escaping from the anode and moving to the cathode through the electrolyte and separator is called discharge, and the opposite process is called charging.

In lithium secondary batteries, the electrolyte reacts to generate gas during primary charging, aging, and charging/discharging immediately after the electrolyte is injected into the electrode assembly, and the generated gas is trapped inside the secondary battery, which can cause problems such as capacity degradation and lithium precipitation. In addition, if a large amount of gas is generated, the internal pressure can increase, which can deform the secondary battery case and cause the secondary battery to explode.

In addition, as the energy density of secondary batteries increases, if a thermal runaway occurs in one cell, the neighboring cells may also be exposed to high temperatures and explode in succession. Therefore, there is a need for a technology to improve the stability of secondary batteries.

According to one aspect of the present disclosure, an object is to provide a battery cell with excellent stability.

According to another aspect of the present disclosure, an object is to provide a battery cell with improved thermal stability.

According to another aspect of the present disclosure, an object is to provide a battery cell with improved thermal stability by absorbing gases generated in the battery cell.

The battery cell according to the present disclosure can be widely applied in the fields of electric vehicles, battery charging stations, energy storage systems, and other green technologies such as photovoltaics and wind power utilizing batteries. Furthermore, the battery cells according to the present disclosure can be used in eco-friendly Mobility, including electric and hybrid vehicles to prevent climate change by suppressing air pollution and greenhouse gas emissions.

### SUMMARY OF THE DISCLOSURE

A battery cell according to an embodiment of the present disclosure may comprise: a case outer member having a receiving space therein, and an electrode assembly received in the receiving space, wherein the case outer member may include a sealing portion formed by bending a plurality of sealing segments.

In an embodiment, the plurality of sealing segments may be bent in an opposite direction to the neighboring sealing segments.

In an embodiment, the electrode assembly may include electrode tabs protruding outwardly of the case outer member exterior, and the electrode tabs may be not protruded into the sealing portion.

In an embodiment, the electrode assembly may include electrode tabs, the case outer member may include protruding portions from which the electrode tabs protrude, and the sealing portion and the protruding portions may be positioned perpendicular to each other.

In an embodiment, the case outer member may be a pouch sheet, and the pouch sheet may include a folded portion, and an outer periphery may be sealed except for the folded portion.

In an embodiment, the electrode assembly may include electrode tabs, and the electrode tabs may protrude longitudinally of the pouch sheet.

In an embodiment, the electrode assembly may include electrode tabs, the electrode tabs may protrude in a longitudinal direction of the pouch sheet, and the sealing portion may be formed in a width direction of the pouch sheet.

In an embodiment, the case outer member may include a first folding surface and a second folding surface formed by folding the pouch sheet, and the plurality of sealing segments may be alternately bent into the first folding surface and the second folding surface.

In an embodiment, the first folding surface and the second folding surface may abut to form the sealing portion, and an adhesive may be applied between the first folding surface and the second folding surface.

A battery cell according to an embodiment of the present disclosure may have excellent stability.

A battery cell according to another embodiment of the present disclosure may have excellent stability because the vent direction is induced.

A battery cell according to another embodiment of the present disclosure can anticipate the vent direction, thereby increasing the safety of the driver and user in an emergency situation such as a fire.

### BRIEF DESCRIPTION OF THE DRAWINGS

FIG. 1 is a perspective view schematically illustrating a battery cell according to an embodiment of the present disclosure.

FIGS. 2 to 5 are drawings schematically illustrating a manufacturing method of a battery cell according to an embodiment of the present disclosure.

### DETAILED DESCRIPTION

Hereinafter, the present disclosure will be described in detail with reference to the accompanying drawings. However, these are exemplary only and do not limit the present disclosure to the specific embodiments illustrated.

Certain terms used herein are for convenience of description only and are not intended to be limiting to the exemplary embodiments.

For example, expressions such as “identical” and “identical to” refer not only to strictly identical states, but also to states in which tolerances, or differences in the degree to which the same function is obtained, exist.

For example, expressions such as “in a direction,” “along a direction,” “side-by-side,” “perpendicular,” “centered,” “concentric,” or “coaxial” that refer to a relative or absolute placement do not only refer to such placement strictly, but also to a state of relative displacement by a tolerance, or by an angle or distance such that the same function is obtained.

For the purpose of describing this disclosure, the following description is based on a spatial Cartesian coordinate system with the X, Y, and Z axes orthogonal to each other. Each axial direction (X-axis direction, Y-axis direction, Z-axis direction) refers to both directions in which the respective axis extends. The following references to the X, Y, and Z directions are for the purpose of clarity of the present disclosure, although it is possible to define these directions differently depending on the reference.

The use of terms such as “first, second, third,” “first, second, third,” and the like to precede components referred to herein is intended to avoid confusion as to the components to which they refer, and is not intended to indicate any order, importance, or master-servant relationship among the components. For example, it is possible to practice an invention comprising only the second component without the first component.

The terminology used in this disclosure is for the purpose of describing specific embodiments and is not intended to limit the scope of the claims. As used in the description of the embodiments and the appended claims, singular forms are intended to include plural forms unless the context clearly indicates otherwise.

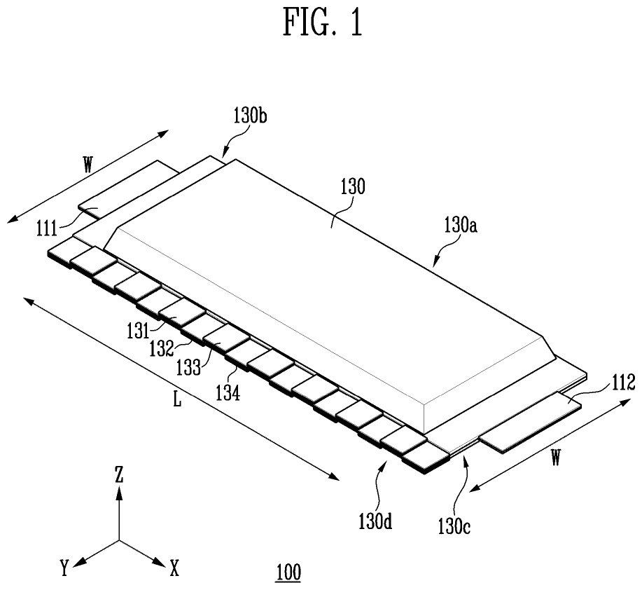

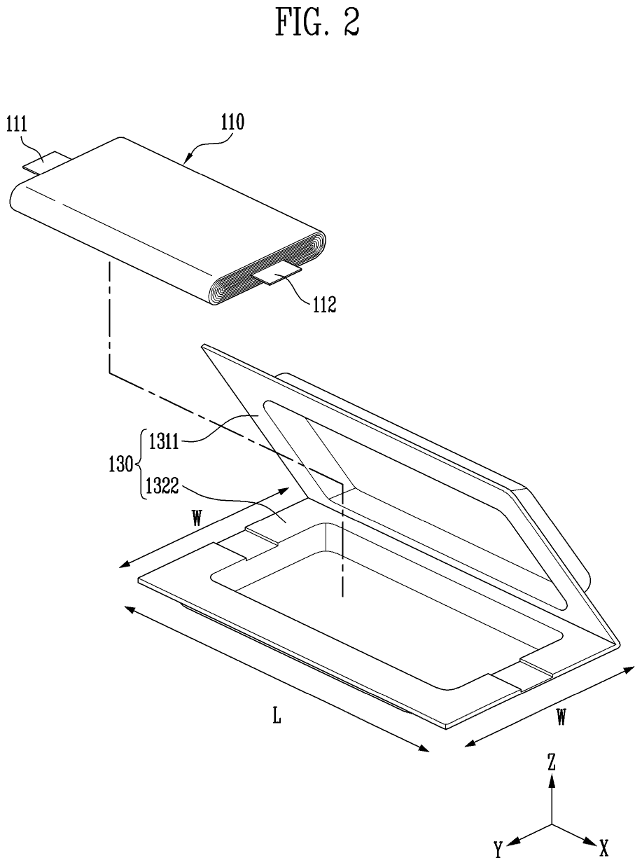

FIG. 1 is a perspective view schematically illustrating a battery cell according to an embodiment of the present disclosure. FIGS. 2 to 5 are drawings schematically illustrating a manufacturing method of a battery cell according to an embodiment of the present disclosure.

Referring to FIG. 1, a battery cell 100 according to an embodiment of the present disclosure may include a case outer member 130 having a receiving space therein, and an electrode assembly 110 received in the receiving space, wherein the case outer member 130 may include a sealing portion 130d formed by bending a plurality of sealing segments 131, 133.

In an embodiment, the battery cell 100 may be a secondary battery capable of being charged and discharged a plurality of times. For example, the secondary cell may be one of, but not limited to, a lithium cobalt cell, a lithium hi-nickel cell, a lithium iron phosphate cell, a lithium ion cell, a lithium polymer cell, a lithium sulfur cell, a nickel-metal hydride cell, a nickel-cadmium cell, a sodium cell, an all-solid-state cell, and various other types of secondary cells.

The case outer member 130 may have a receiving space, and the electrode assembly 110 may be received in the receiving space.

The electrode assembly 110 may include a first electrode and a second electrode, and a separator disposed between the first and second electrodes. As shown in FIG. 2, the electrode assembly 110 may be plate-like.

The first electrode may be an anode, the anode comprising an anode collector and an anode composite layer disposed on at least one side of the anode collector. The anode collector may comprise stainless steel, nickel, aluminum, titanium, or an alloy thereof. The anode collector may comprise aluminum or stainless steel with a surface treatment of carbon, nickel, titanium, or silver. The anode composite layer may comprise an anode active material, a binder, and a conductive material.

The anode active material may comprise a compound capable of reversibly intercalating and de-intercalating lithium ions. By way of example, but not limitation, the anode active material may comprise a lithium-nickel metal oxide. The lithium-nickel metal oxide may further comprise at least one of cobalt (Co), manganese (Mn), and aluminum (Al).

The binder may be polyvinylidene fluoride (PVDF), poly(vinylidene fluoride-co-hexafluoropropylene) copolymer, polyacrylonitrile, polymethylmethacrylate, acrylonitrile butadiene rubber (NBR), polybutadiene rubber (BR), styrene-butadiene rubber (SBR), and the like.

The conductive material may be added to enhance the conductivity and/or mobility of lithium ions or electrons in the anode composite layer. For example, the materials may include, but are not limited to, carbon-based materials such as graphite, carbon black, acetylene black, ketjen black, graphene, carbon nanotubes, vapor-grown carbon fiber (VGCF), carbon fiber, etc. and/or metal-based materials such as tin, tin oxide, titanium oxide, LaSrCoO₃, LaSrMnO₃, perovskite materials, etc.

The second electrode may be a cathode, the cathode comprising a cathode collector and a cathode composite layer disposed on at least one side of the cathode collector. The cathode collector may include, but is not limited to, a copper foil, a nickel foil, a stainless steel foil, a titanium foil, a nickel foam, a copper foam, a polymer substrate coated with a conductive metal, and the like. The cathode composite layer may comprise a cathode active material, a binder, and a conductive agent.

As the cathode active material, a material capable of adsorbing and desorbing lithium ions may be used. For example, the cathode active material may be a carbon-based material, such as crystalline carbon, amorphous carbon, carbon composite, carbon fiber, or the like; a lithium metal; a lithium alloy; a silicon-containing material; or a tin-containing material.

Examples of amorphous carbons include hard carbon, soft carbon, coke, mesocarbon microbeads (MCMB), mesophase pitch-based carbon fiber (MPCF), and the like.

Examples of the crystalline carbon include graphitic carbons such as natural graphite, artificial graphite, graphitized coke, graphitized MCMB, graphitized MPCF, and the like.

The lithium metal may be pure lithium metal or lithium metal with a protective layer formed for inhibiting dendrite growth, etc. In an embodiment, a lithium metal-containing layer deposited or coated on the cathode collector may be used as the cathode active material layer. In an embodiment, a lithium thin film layer may be used as the cathode active material layer.

The elements included in the lithium alloy may include aluminum, zinc, bismuth, cadmium, antimony, silicon, lead, tin, gallium, or indium.

The silicon-containing material may provide increased capacity characteristics. The silicon-containing material may include Si, SiOₓ (0<x<2), metal-doped SiOₓ (0<x<2), silicon-carbon composites, and the like. The metal may comprise lithium and/or magnesium, and the metal doped SiOₓ (0<x<2) may comprise a metal silicate.

The binder and conductive material used in the cathode composite layer may be the same as those used in the anode composite layer.

The separator may be configured to prevent an electrical short between the anode and cathode, and to allow the flow of ions to occur. The separator may comprise, but is not limited to, a porous polymeric film or a porous nonwoven fabric. The porous polymeric film may comprise a polyolefin-based polymer, such as an ethylene polymer, a propylene polymer, an ethylene/butene copolymer, an ethylene/hexene copolymer, and an ethylene/methacrylate copolymer. The porous nonwoven fabric may include high melting point glass fibers, polyethylene terephthalate fibers, and the like. The separator may also comprise a ceramic-based material. For example, inorganic particles may be coated on the polymeric film or dispersed in the polymeric film to improve heat resistance.

The separator may have a monolayer or bilayer structure comprising the polymeric film and/or nonwoven fabric described above.

Also, although not shown, in an embodiment, the electrode assembly may be winding, stacking, z-folding, or stack-folding.

In an embodiment, the electrode assembly 110 may include electrode tabs 111, 112 for applying electricity to the first and second electrodes. The first and second electrode tabs 111, 112 may protrude to the outside of the case outer member 130. In an embodiment, the case outer member 130 may include protruding portions 130b, 130c from which the electrode tabs 111, 112 protrude.

In an embodiment, the first and second electrode tabs 111, 112 may protrude in opposite directions from each other. The first electrode tab 111 may protrude in the −x-axis direction and the second electrode tab 112 may protrude in the +x-axis direction.

Alternatively, in an embodiment, the first and second electrode tabs may protrude in the same direction.

In an embodiment, the electrode tabs 111, 112 may not protrude into the sealing portion 130d. In an embodiment, the sealing portion may be formed on the portion from which the electrode tabs are not protruded.

In an embodiment, the electrode assembly may include electrode tabs 111, 112, the case outer member may include protruding portions 130b, 130c from which the electrode tabs 111, 112 protrude, and the sealing portion and the protruding portions 111, 112 are positioned perpendicular to each other.

For example, the protruding portions 130b, 130c from which the electrode tabs 111, 112 protrude may be positioned perpendicular to the sealing portion 130d and each other. The protruding portions 130b, 130c may be located in a length direction L of the case outer member, and the sealing portion 130d may be located in a width direction W.

In an embodiment, the battery cell 100 may include an electrolyte. The electrolyte may be a medium for transferring ions or current between the first electrode (anode) and the second electrode (cathode) of the electrode assembly 110. In an embodiment, a non-aqueous electrolyte may be used as the electrolyte.

The non-aqueous electrolyte comprises a lithium salt as an electrolyte and an organic solvent, the lithium salt being represented, for example, by Li⁺X⁻, and the anions of the lithium salt as F⁻, Cl⁻, Br⁻, I⁻, NO₃, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

The organic solvent may comprise an organic compound that has sufficient solubility for the lithium salt, additive, and is not reactive in the cell. The organic solvent may include at least one of, for example, a carbonate-based solvent, an ester-based solvent, an ether-based solvent, a ketone-based solvent, an alcohol-based solvent, and a non-protonated solvent. The organic solvents may include, for example, propylene carbonate (PC), ethylene carbonate (EC), butylene carbonate, diethyl carbonate (DEC), dimethyl carbonate (DMC), ethylmethyl carbonate (EMC), methylpropyl carbonate, ethylpropyl carbonate, dipropyl carbonate, vinylene carbonate, methylacetate (MA), ethyl acetate (EA), n-propyl acetate (n-propylacetate, n-PA), 1,1-dimethylethyl acetate (DMEA), methyl propionate (MP), and ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF) and 2-methyltetrahydrofuran, ethyl alcohol, isopropyl alcohol, dimethyl sulfoxide, acetonitrile, dimethoxyethane, diethoxyethane, sulfolane, gamma-butyrolactone, and propylene sulfite. These may be used alone or in combination of two or more.

In an embodiment, the case outer member 130 may not be particularly limited in shape as long as it has a receiving space inside. As shown in FIGS. 1 to 5, the case outer member 130 may be a pouch sheet. The case outer member may be polygonal in shape, such as cylindrical or square. The battery cells 100 may be categorized based on the shape of the case outer member, including, but not limited to, pouch-shaped, square-shaped, or cylindrical battery cells.

The sealing portion 130d may comprise a plurality of sealing segments 131, 133. In an embodiment, the plurality of sealing segments may be bent in opposite directions to neighboring sealing segments. This may increase the engagement force of the sealing portion 130d. As the engagement force of the sealing portion 130d is increased, the sealing portion 130d may be prevented from fracturing. In an embodiment, as the engagement force of the sealing portion 130d increases, the protruding portions 130b, 130c from which the electrode tabs 111, 112 protrude may break before the sealing portion 130d. Accordingly, a vent direction may be induced into the protruding portions 130b, 130c.

As the battery ages or is exposed to a high temperature environment, gas may be generated inside the battery cell, which may increase the internal pressure and cause the battery cell to vent. Random venting of battery cells in emergency situations can be even more dangerous. Unguided venting or ignition can result in the transfer of hot electrolyte, gas, electrodes, and other combustibles to neighboring battery cells. The transferred flammables can cause fires in neighboring battery cells. Flames can also be directed toward the driver of an electric vehicle with a battery. The thinness of the pouch-type rechargeable battery allows for large capacity batteries to be realized, but the large capacity requires more attention to safety.

The battery cell according to an embodiment of the present disclosure may have a vent direction that can be guided and has excellent stability.

Hereinafter, a manufacturing method of a battery cell according to an embodiment of the present disclosure will be described in detail. By the manufacturing method described hereinafter, the structure of the battery cell can be more clearly understood and specified.

FIGS. 2 through 5 are drawings schematically illustrating a manufacturing method of a battery cell according to an embodiment of the present disclosure.

First, as shown in FIG. 2, a case outer member 130 may be provided, and an electrode assembly 110 may be received within the case outer member 130.

In an embodiment, the case outer member 130 may be a pouch sheet. Without limitation, the pouch sheet may be a sheet with an insulating layer, a metal layer, and a resin layer laminated thereto.

In an embodiment, the case outer member 130 may include a first folding surface 131 and a second folding surface 1322 formed by folding the pouch sheet, and the plurality of sealing segments may be alternately bent into the first folding surface 1311 and the second folding surface 1322.

For example, the pouch sheet may receive the electrode assembly 110, and the pouch sheet may be folded to receive the electrode assembly. The pouch sheet may be folded to form a first folding surface 1311 and a second folding surface 1322. The first folding surface 1311 and the second folding surface 1322 may be connected by the folded portion 130a.

The first and second electrode tabs 111, 112 of the electrode assembly 110 may be arranged to protrude outwardly of the pouch sheet. In an embodiment, the first and second electrode tabs 111, 112 may protrude in opposite directions from each other. The first and second electrode tabs 111, 112 may protrude in the longitudinal direction L of the pouch sheet.

Accordingly, the case outer member 130 may have protruding portions 130b, 130c formed in which the electrode tabs 111, 112 protrude.

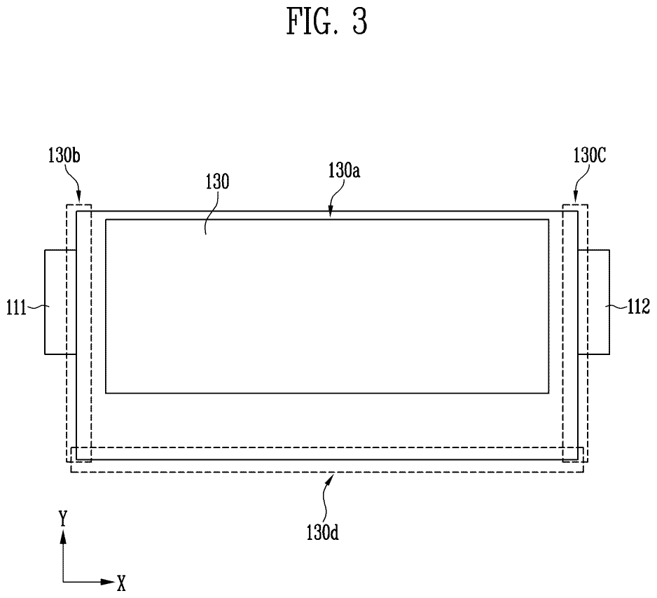

Next, as shown in FIG. 3, the case outer member 130 may be sealed after receiving the electrode assembly 110.

The case outer member 130 may be sealed around an outer periphery surrounding the electrode assembly received in the case outer member 130. In an embodiment, if the case outer member 130 is a pouch sheet, the outer periphery 130b, 130c, 130d may be sealed except for the folded portion 130a. When the pouch sheet is folded, the first folding surface 1311 and the second folding surface 1322 come into contact, and the first folding surface 1311 and the second folding surface 1322 that come into contact may be sealed. Without limitation, the sealing may be accomplished by welding or the like.

In an embodiment, the case outer member 130 may be a pouch sheet, and the pouch sheet may include a folded portion, and may be folded to receive the electrode assembly 110, and an outer periphery 130b, 130c, 130d may be sealed except for the folded portion 130a.

In an embodiment, the first folding surface 1311 and the second folding surface 1322 may abut to form the sealing portion 130d, and an adhesive may be applied between the first folding surface 1311 and the second folding surface 1322.

For example, an adhesive may be applied between the first folding surface 1311 and the second folding surface 1322 of the case outer member 130. Accordingly, the engagement force of the sealing portion 130d may be improved.

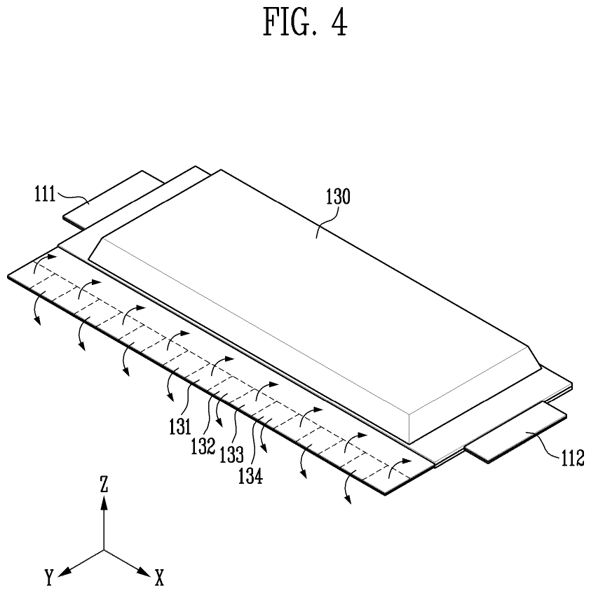

Next, as shown in FIG. 4, an end of the case outer member may be cut to form a plurality of sealing segments.

In an embodiment, the electrode assembly 110 may include electrode tabs 111, 112 protruding outwardly of the case outer member 130 exterior, and the electrode tabs 111, 112 may be not protruded into the sealing portion 130d.

For example, a plurality of sealing segments 131, 132, 133, 134 may be formed by cutting an end where the electrode tabs 111, 112 are not protruded.

In an embodiment, an end of the case outer member 130 in widthwise direction W may be cut. A folded portion 130a may be formed at the other end of the case outer member.

The cut may be made from the outside toward the case outer member by a predetermined length.

The number of the sealing segments is not limited and may be suitably selected according to the length in the width direction W of the case outer member. By way of example, but not limitation, the sealing segments may be two or more, five or more, ten or more, or twenty or more.

Further, the shape of the sealing segments is not particularly limited. As shown, the sealing segments may be rectangular in shape. The sealing segments may also have the shape of a triangle, rhombus, or the like.

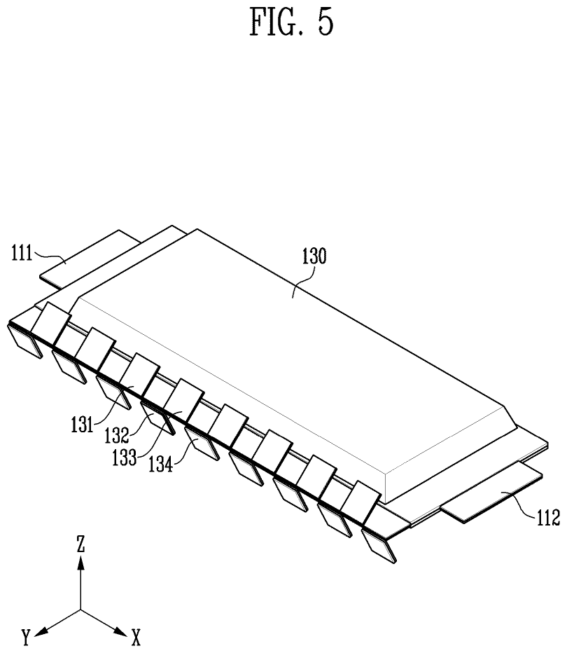

Next, as shown in FIG. 5, the plurality of sealing segments 131, 132, 133, 134 may be bent in opposite directions to form sealing portion 130d.

In an embodiment, the electrode tabs 111, 112 may protrude in the lengthwise direction L of the pouch sheet, and the sealing portion 130d may be formed in the width direction W of the pouch sheet.

In an embodiment, the sealing segments may be bent in an opposite direction to the adjacent sealing segments. The plurality of sealing segments may be alternately bent into the first and second folding surfaces.

A sealing segment may be bent to the first folding surface 1311 of the case outer member, and another sealing segment adjacent to the sealing segment may be bent to the second folding surface 1322 of the case outer member. It may be understood that the first folding surface 1311 of the case outer member is in the +z-axis direction and the second folding surface 1322 of the case outer member is in the −z-axis direction. In this cross-folding manner, the sealing portion 130d of the case outer member may have an improved engagement force.

By improving the engagement force of the sealing portion of the case outer member, the vent direction can be guided to the electrode tab protruding portion when the pressure inside the battery cell rises. By guiding the vent direction of the battery cell in the desired direction, the direction of flammable substances such as high-temperature electrolyte, gas, and electrodes transferred from the battery cell in an emergency situation such as a fire can be predicted. By predicting the vent direction of the battery cell, the safety of the driver and users can be improved in emergency situations such as fire. It also prevents fire from spreading to neighboring cells. Accordingly, the safety of battery cells may be improved.

An embodiment of the present disclosure may be a battery module comprising one or more battery cells. The battery module may include one or more battery cells 100. The composition and features of the battery cells 100 are as described above.

Further, according to an embodiment of the present disclosure, the one or more battery modules may comprise a battery pack. In addition to the battery modules, the battery pack may further comprise a pack case for storing the battery modules, various devices for controlling the charging and discharging of the battery modules, such as a battery management system (BMS), current sensors, fuses, and the like.

The present disclosure may be practiced in various variations, and the scope of the disclosure is not limited to the embodiments described above. Accordingly, if a variation includes components of the patent claims of the present disclosure, it should be considered to be within the scope of the disclosure.

What is claimed is:

1. A battery cell comprising:
a case outer member having a receiving space therein; and
an electrode assembly received in the receiving space;
wherein the case outer member includes a sealing portion formed by bending a plurality of sealing segments.

2. The battery cell according to claim 1, wherein the plurality of sealing segments are bent in an opposite direction to the neighboring sealing segments.

3. The battery cell according to claim 1, wherein the electrode assembly includes electrode tabs protruding outwardly of the case outer member exterior, and the electrode tabs are not protruded into the sealing portion.

4. The battery cell according to claim 1, wherein the electrode assembly includes electrode tabs, the case outer member includes protruding portions from which the electrode tabs protrude, and the sealing portion and the protruding portions are positioned perpendicular to each other.

5. The battery cell according to claim 1, wherein the case outer member is a pouch sheet, and the pouch sheet includes a folded portion, and an outer periphery is sealed except for the folded portion.

6. The battery cell according to claim 5, wherein the electrode assembly includes electrode tabs, and the electrode tabs protrude longitudinally of the pouch sheet.

7. The battery cell according to claim 5, wherein the electrode assembly includes electrode tabs, the electrode tabs protrude in a longitudinal direction of the pouch sheet, and the sealing portion is formed in a width direction of the pouch sheet.

8. The battery cell according to claim 5, wherein the case outer member includes a first folding surface and a second folding surface formed by folding the pouch sheet, and the plurality of sealing segments are alternately bent into the first folding surface and the second folding surface.

9. The battery cell according to claim 8, wherein the first folding surface and the second folding surface abut to form the sealing portion, and an adhesive is applied between the first folding surface and the second folding surface.
